(19) United States
(12) Patent Application Publication
(10) Pub. No.: US 2016/0125422 A1
(43) Pub. Date: May 5, 2016

(54) LOCATION-BASED POLICY GUIDANCE SYSTEM

(71) Applicant: The Travelers Indemnity Company, Hartford, CT (US)

(72) Inventors: Monica N. Blanco, Plantsville, CT (US); Marcel J. Lessard, Southington, CT (US); Brett Mortimer, Bloomfield, CT (US); Hayden Crumrine, Bristol, CT (US); Lekshmi Nair, Manchester, CT (US); Kimberly A. Inglis, Clinton, CT (US)

(21) Appl. No.: 14/527,964

(22) Filed: Oct. 30, 2014

(51) Int. Cl. G06Q 30/00; G06Q 40/02; G06Q 40/08

(52) U.S. Cl. CPC G06Q 30/018; G06Q 40/08; G06Q 40/02

(57) ABSTRACT

A system includes a processing device and a memory device in communication with the processing device. The memory device stores instructions that when executed by the processing device result in displaying a list that includes two or more geographic locations in which an entity has assets. The system can determine which geographic locations are selected and determine an inclusion and exclusion rule set specific to each of the selected geographic locations. A link can be generated between each of the selected geographic locations and the inclusion and exclusion rule set specific to each of the selected geographic locations. A record set can be output on an interactive user display including each of the selected geographic locations and an instance of the link to display the inclusion and exclusion rule set specific to each of the selected geographic locations based on a link selection.

### BACKGROUND

In industries such as banking, finance, and insurance, compliance with a number of location-specific rules and government regulations is critical. For example, in the context of preparing a workers compensation insurance policy, coverage rules can vary by state and by legal entity type, e.g., corporation, partnership, sole proprietorship, etc. Each state can set its own limits for minimum payroll limits and maximum payroll limits per legal entity type. Additionally, some states can define different limits depending upon business type. Each state may update respective rules and limits at different times. Furthermore, each state may define its own set of forms to cover particular situations related to insurance coverage options. The high degree of variability between state-specific rules, limits, and forms, as well as variable timing of updating rules, limits, and forms makes it challenging for professionals to ensure accuracy, particularly when working across multiple regulatory jurisdictions. This can result in a time consuming process of frequently researching, locating, and identifying proper rules, limits, and forms using a number of different industry sites and/or publications. The risk of errors increases where multiple systems for lookup are used and unbounded data/form selection is performed.

If multiple individual searches of various databases occur across a computing network, then computer system and network performance is typically degraded, as each search requires processing resource time, network bandwidth, and temporary storage space to capture results of multiple searches. Repeated data entry and numerous searches across multiple computer systems to retrieve similar and sometimes redundant information can reduce overall computer system and network performance.

### BRIEF DESCRIPTION OF THE DRAWINGS

The subject matter which is regarded as the invention is particularly pointed out and distinctly claimed in the claims at the conclusion of the specification. The features and advantages of the invention are apparent from the following detailed description taken in conjunction with the accompanying drawings in which:

FIG. 1 depicts a block diagram of a system according to some embodiments of the present invention;

FIG. 2 depicts a block diagram of a system according to some embodiments of the present invention;

FIG. 3A depicts a policy guidance table according to some embodiments of the present invention;

FIG. 3B depicts a minimum-maximum guide table according to some embodiments of the present invention;

FIG. 4 depicts an interactive user display and user input interface according to some embodiments of the present invention;

FIG. 5 depicts another example of an interactive user display and user input interface according to some embodiments of the present invention;

FIG. 6 depicts an example of include-exclude guidance according to some embodiments of the present invention;

FIG. 7 depicts an example of a form according to some embodiments of the present invention;

FIG. 8 depicts another example of an interactive user display and user input interface according to some embodiments of the present invention;

FIG. 9 depicts an example of a payroll limitation guide according to some embodiments of the present invention;

FIG. 10 depicts a process flow according to some embodiments of the present invention;

FIG. 11 depicts a process flow according to some embodiments of the present invention; and

FIG. 12 depicts a process flow according to some embodiments of the present invention.

### DETAILED DESCRIPTION

According to an embodiment, a system for location-based policy preparation guidance is provided as part of a data entry and analysis system. The system may be used in preparing an insurance policy or in other location-specific activities in which rules, limits, and/or forms depend upon a geographic location. In order to improve computing system performance and throughput, multiple geographic locations can be selected using a common interface to determine rule sets specific to each geographic location. A link can be generated between each of the selected geographic locations and a respective rule set specific to each of the selected geographic locations. A record set can be output on an interactive display that includes an instance of the link for each of the selected geographic locations to display the rule set specific to each of the selected geographic locations based on a link selection. As one example, the system can be used as part of an insurance rate/quote/issue system that gathers policy information; performs underwriting and eligibility analysis, including determining one or more associated geographic location-based rule sets; presents a user with rules, limits, and forms; and generates a quotation for an insurance policy. Based on the analysis by the system, links can be presented during the insurance rate/quote/issue process to display rule sets specific to selected geographic locations and may also include links to forms and other guidance based on the selected geographic locations, while data associated with the selected geographic locations are locally available in computer system memory, such that the number or volume of network and data storage system accesses can be reduced, thereby improving overall computer system performance and throughput. The term “guidance,” as used herein, can refer to regulating bureau-mandated or state-mandated requirements, as well as information that may be of assistance, but is not necessarily advice.

In an exemplary embodiment, policy guidance is provided that simplifies a policy preparation process by integrating geographic location-based rules, forms, and limit guidance to constrain a number of options available in the policy preparation process based on location and legal entity type. Geographic location-based rules can be bureau-mandated or regionally-mandated requirements, such as rules promulgated from an agency or department at a state level, a territory level, a municipality level, etc. The processes disclosed herein may be used for insurance quotation generation, financial systems, legal services, banking services, medical record management, shipping classification, economic data classification, or any such application where location-based rule sets can be linked to selection of multiple geographic locations. Accordingly, although a detailed example is described herein in reference to an insurance rate/quote/issue process, the system described herein may be generally applicable to any number of industry or governmental systems beyond insurance.

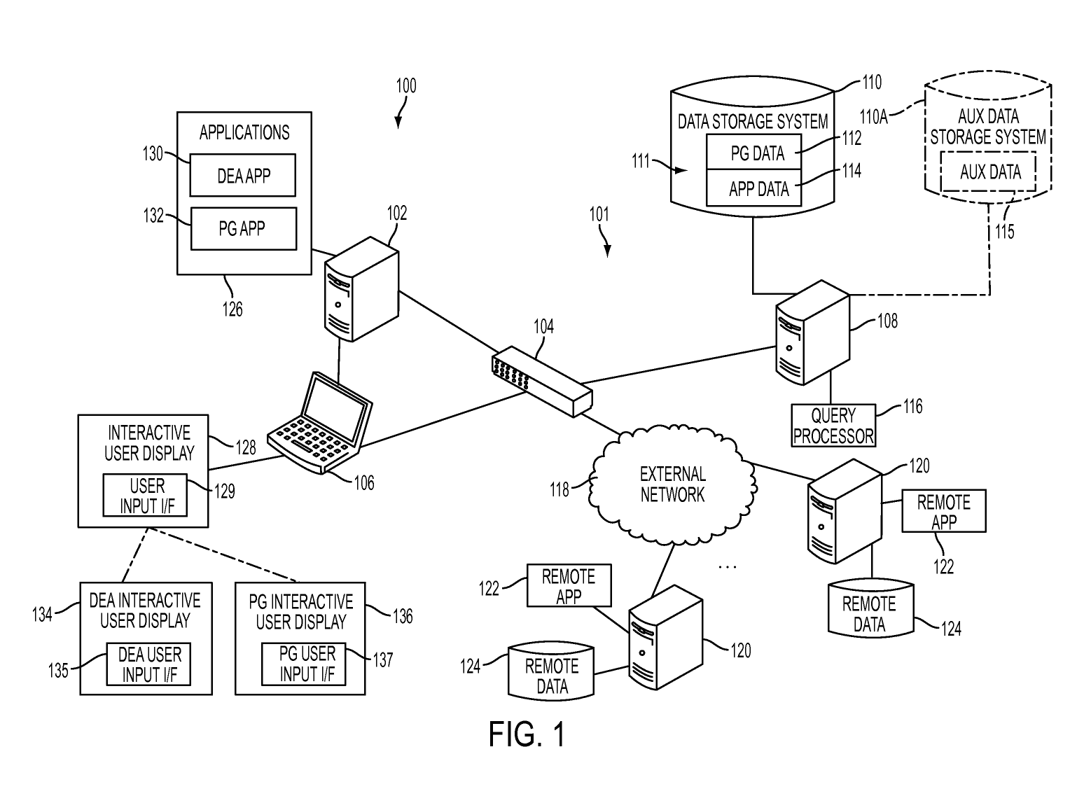

Turning now to FIG. 1, a system 100 is depicted upon which a location-based policy guidance process may be implemented. The system 100 includes a data entry and analysis system 101, which may include an application server 102 coupled to a mediation layer gateway 104. A user system 106 can be coupled to the application server 102 and the mediation layer gateway 104. The mediation layer gateway 104 is also coupled to a query server 108 that accesses and indexes data in a data storage system 110. The data storage system 110 can hold a database 111 that may include a variety of data, such as policy guidance data 112, application data 114, as well as other data (not depicted). In an exemplary embodiment, the policy guidance data 112 can include data organized in one or more tables of records that may be selected as part of the interactive selection process. The application data 114 may include other data values to support an application program that uses the interactive selection process. For example, in an insurance quotation application, the policy guidance data 112 may include inclusion and exclusion rule sets, compliance forms, and minimum-maximum guidance, while the application data 114 can include applicant information, pricing models, underwriting guidelines, and the like. A query processor 116 may execute on the query server 108 to retrieve selected records from the database 111 based on a query from the application server 102, the user system 106, or other system.

The database 111 may include or link to records stored in other data storage systems, such as an auxiliary data storage system 110A. The auxiliary data storage system 110A can hold auxiliary data 115 that supports or supplements data retrieval from the policy guidance data 112. For instance, certain record types and data, such as compliance forms, can be stored in the auxiliary data 115 of the auxiliary data storage system 110A. The auxiliary data storage system 110A may represent a legacy data source that is accessible by the query server 108 as part of searching and presentation of extended and related data sets. Alternatively, the auxiliary data storage system 110A can be omitted and the auxiliary data 115 can be merged with the database 111 in the data storage system 110.

The data entry and analysis system 101 may access an external network 118 via the mediation layer gateway 104 and/or one or more other firewalls or gateways (not depicted). One or more remote servers 120 can be accessed through the external network 118. Each remote server 120 can include one or more remote applications 122 and remote data 124. The external network 118 can be a large-scale, global network, such as the Internet. The remote data 124 may be accessed by the user system 106, for instance, via a hyperlink. The remote data 124 can also be used to update data in the database 111 and/or auxiliary data 115. In one embodiment, the policy guidance data 112 is updated by the data entry and analysis system 101 making requests to access the remote data 124 and reformatting the remote data 124 as needed to store in the policy guidance data 112. In an alternate embodiment, one of the remote applications 122 with proper authentication can push updates from the remote data 124 to the policy guidance data 112 and mark the data as updated.

The application server 102 can source a number of application programs 126 that may be executed by the application server 102, the user system 106, or in a distributed manner between the application server 102, the user system 106, and/or other systems. The user system 106 includes an interactive user display 128 to display information and a user input interface 129 that collects inputs from a user. The interactive user display 128 can be generated by one or more of the applications 126 on the application server 102 and provides information and input options for the user input interface 129. For example, the interactive user display 128 can appear as a data entry template where the user input interface 129 includes user modifiable fields to enter data values or make selections.

The mediation layer gateway 104 can provide an enterprise service bus (ESB) that routes various communications and supports a number of protocols within the system 100. For example, the mediation layer gateway 104 may process Simple Object Access Protocol (SOAP) requests and responses relative to the application server 102, Representational State Transfer (REST) requests and responses using Asynchronous JavaScript™ and extensible markup language (XML) (AJAX) relative to the user system 106, Hypertext Transfer Protocol (HTTP) query requests and responses relative to the query server 108, and any number of known protocols relative to the external network 118. A number of other protocols can be used throughout the system 100. For instance, the application server 102 and user system 106 may support JavaServer™ Faces (JSF)/Facelet requests and responses, and the query server 108 may access the data storage system 110 and/or the auxiliary data storage system 110A using Structured Query Language (SQL) and/or Open Database Connectivity (ODBC).

In the example of FIG. 1, each of the application server 102, the mediation layer gateway 104, the user system 106, the query server 108, the data storage system 110, and the remote servers 120 can include a processor (e.g., a processing device such as one or more microprocessors, one or more microcontrollers, one or more digital signal processors) that receives instructions (e.g., from memory or like device), executes those instructions, and performs one or more processes defined by those instructions. Instructions may be embodied, for example, in one or more computer programs and/or one or more scripts. In one example, the data entry and analysis system 101 executes computer instructions for implementing the exemplary processes described herein. Instructions that implement various process steps can be executed by different elements of the data entry and analysis system 101. For example, user input on the user system 106 can result in a request for data as a query that is processed by the query server 108. User inputs can also result in requests to the application server 102 which may also result in another request for data as a query processed by the query server 108. Although depicted separately, one or more of the application server 102, the mediation layer gateway 104, the user system 106, the query server 108, and the data storage system 110 can be combined or further subdivided. In an embodiment, the data entry and analysis system 101 is implemented by an insurance company.

In some embodiments, the application server 102 may include one or more electronic and/or computerized controller devices such as computer servers communicatively coupled to interface with the user system 106 (e.g., one or more client computers) and/or third-party devices (directly and/or indirectly). According to some embodiments, the application server 102 may be located remote from the user system 106. The application server 102 may also or alternatively include a plurality of electronic processing devices located at one or more various sites and/or locations. In an exemplary embodiment, the application server 102 is a JBoss™ application server.

According to some embodiments, the application server 102 and/or the user system 106 may store and/or execute specially programmed instructions to operate in accordance with one or more embodiments described in this disclosure. The application server 102 and/or the user system 106 may, for example, execute one or more programs that provide location-based policy preparation guidance as part of a policy preparation process.

The user system 106 may be implemented using a computer executing one or more computer programs for carrying out processes described herein. In one embodiment, the user system 106 may be a personal computer (e.g., a laptop, desktop, etc.), a network server-attached terminal (e.g., a thin client operating within an internal network of the application server 102), or a portable device (e.g., a tablet computer, personal digital assistant, smart phone, etc.). In an embodiment, the user system 106 is operated by an insurance professional, such as a product manager, broker, or agent of an insurance company. It will be understood that while only a single user system 106 is shown in FIG. 1, there may be multiple user systems 106 communicatively coupled to the application server 102 and mediation layer gateway 104. The user systems 106 can connect to elements of the data entry and analysis system 101 via an enterprise network and/or through the external network 118.

Various networks may be used to establish communication within the system 100, such as a wide area network (WAN), a local area network (LAN), a global network (e.g., Internet), a virtual private network (VPN), and/or an intranet. Communication within the system 100 may be implemented using a wireless network or any kind of physical network implementation known in the art.

Information stored in the data storage system 110 and/or the auxiliary data storage system 110A may be retrieved and manipulated via the query server 108, based on requests from the application server 102 or the user system 106, for example. The data storage system 110 and/or the auxiliary data storage system 110A may be implemented using a variety of devices for storing electronic information. It is understood that the data storage system 110 and/or the auxiliary data storage system 110A may be implemented using memory contained in the query server 108 or it may be a separate physical system, as shown in FIG. 1. It will be understood that multiple storage devices may be employed in the data storage system 110 and/or the auxiliary data storage system 110A. For example, the storage devices of the data storage system 110 and/or the auxiliary data storage system 110A may be dispersed across the system 100, and each of the storage devices may be logically addressable as a consolidated data source across a distributed environment. In an embodiment, the data storage system 110 and/or the auxiliary data storage system 110A may include one or more third-party data devices. According to some embodiments, data may be stored by or provided via one or more optional third-party data devices of system 100. A third-party data device may comprise, for example, an external hard drive or flash drive connected to the system 100, a remote third-party computer system for storing and serving data (e.g., claim data, business data, state insurance data) for use in performing one or more functions described in this disclosure, or a combination of such remote and/or local data devices. In one embodiment, one or more companies and/or end users may subscribe to or otherwise purchase data (e.g., demographic, financial, employment, claim, or other data) from a third party and receive the data via the third-party data device.

Each of the application server 102, the mediation layer gateway 104, the user system 106, the query server 108, the data storage system 110, the auxiliary data storage system 110A, and the remote servers 120 can include a local data storage device, such as a memory device. A memory device, also referred to herein as “computer-readable memory” (e.g., non-transitory memory devices as opposed to transmission devices or media), may generally store program instructions, code, and/or modules that, when executed by a processing device, cause a particular machine to function in accordance with one or more embodiments described herein.

The applications 126 of application server 102 can include multiple application programs or sequences of instructions to implement processes as described herein. For example, a data entry and analysis (DEA) application 130 may include a sequence of executable instructions that enable a user to enter relevant information, access associated application data 114, perform analysis tasks such as determining eligibility, initiate a classification process, and provide results and reports. Although depicted as a single block in FIG. 1, the DEA application 130 can include a collection of modules, routines, functions, scripts, and the like to implement a data entry and analysis process. A policy guidance (PG) application 132 may provide selection guidance for inclusion and exclusion specific rule sets based on selected geographic locations, compliance forms, and a minimum-maximum guide. The PG application 132 can interface with the query processor 116 to perform lookup and reporting of the policy guidance data 112 in combination with the DEA application 130. The query processor 116 may provide rapid feedback to the PG application 132 by maintaining a number of indexes into the policy guidance data 112. The query processor 116 or another process on the query server 108 may include an automated process that periodically updates and indexes the database 111. The query processor 116 can also support a variety of searches to select matching data values and related data. Although depicted separately, the DEA application 130 and the PG application 132 can be combined to form a single application in the applications 126. The PG application 132 may alternatively be decomposed into a number of sub-applications, modules, or functional units.

According to a design pattern of the interactive user display 128 and user input interface 129, the user system 106 can include one or more instances of a DEA interactive user display 134 with a DEA user input interface 135 that interacts with the DEA application 130. The DEA interactive user display 134 may define one or more form templates to be populated with data obtained through the application server 102 and/or the query server 108 as a Web browser-based or stand-alone application implementation. The DEA interactive user display 134 and DEA user input interface 135 may include a sequence of display screens and user interfaces to be presented at different points during progression of the process. For example, different interactive interface views can be produced to enter specific data items, respond to questions, and output results.

Also according to a design pattern of the interactive user display 128 and user input interface 129, a PG interactive user display 136 and PG user input interface 137 can be defined separately or be included as part of the DEA interactive user display 134 and DEA user input interface 135. The PG interactive user display 136 and PG user input interface 137 interact with the PG application 132 according to one or more form templates populated with user data and data obtained through the application server 102 and/or the query server 108 as a Web browser-based or stand-alone application implementation.

One example of a general sequence of interactions that can be initiated by a user in the system 100 begins with user input received on the user input interface 129 (which may be the DEA user input interface 135 or PG user input interface 137), for instance, from a keyboard and/or mouse/pointer device. When a request is received at the user system 106, the request may be forwarded to the mediation layer gateway 104 using an AJAX interface as a REST-based request. In response, the mediation layer gateway 104 can generate a query request for the query server 108 as an HTTP query request. The query processor 116 performs a query process to find potential matches to the query request in the data storage system 110 and/or the auxiliary data storage system 110A and a response may be provided as an HTTP query response from the query server 108 to the mediation layer gateway 104. Subsequently, the mediation layer gateway 104 can make the query response available to be obtained by an AJAX interface as a REST-based response for the user system 106. With regard to the application server 102, a request from a client can be obtained, such as a facelet request obtained by the application server 102 from the user system 106. The request can be sent from the application server 102 to the mediation layer gateway 104 as a SOAP-based request using a JAX-web service. Again, the mediation layer gateway 104 can use an HTTP query request and an HTTP query response in communicating with the query server 108. A response can be obtained from the mediation layer gateway 104 by the application server 102 as a SOAP-based response using a JAX-web service. The application server 102 can provide the facelet response to the user system 106.

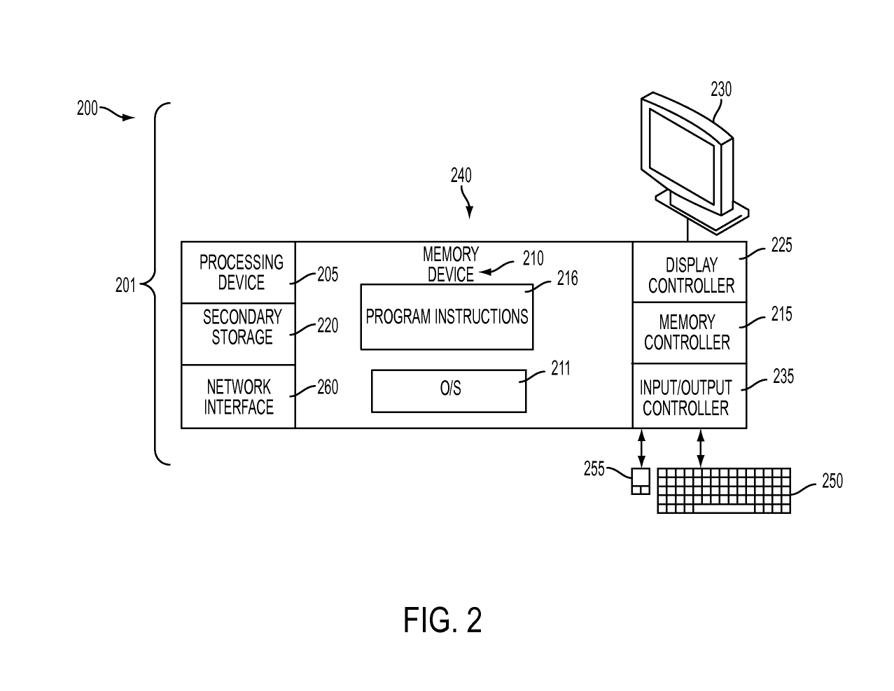

FIG. 2 depicts a block diagram of a system 200 according to an embodiment. The system 200 is depicted embodied in a computer 201 in FIG. 2. The system 200 is an example of the user system 106 of FIG. 1. The application server 102, the mediation layer gateway 104, the query server 108, and the remote servers 120 of FIG. 1 can also include similar computer elements as depicted in the computer 201 of FIG. 2.

In an exemplary embodiment, in terms of hardware architecture, as shown in FIG. 2, the computer 201 includes a processing device 205 and a memory device 210 coupled to a memory controller 215 and an input/output controller 235. The input/output controller 235 can be, for example, but not limited to, one or more buses or other wired or wireless connections, as is known in the art. The input/output controller 235 may have additional elements, which are omitted for simplicity, such as controllers, buffers (caches), drivers, repeaters, and receivers, to enable communications. Further, the computer 201 may include address, control, and/or data connections to enable appropriate communications among the aforementioned components.

In an exemplary embodiment, a keyboard 250 and mouse 255 or similar devices can be coupled to the input/output controller 235. Alternatively, input may be received via a touch-sensitive or motion sensitive interface (not depicted). The computer 201 can further include a display controller 225 coupled to a display 230.

The processing device 205 is a hardware device for executing software, particularly software stored in secondary storage 220 or memory device 210. The processing device 205 can be any custom made or commercially available computer processor, a central processing unit (CPU), an auxiliary processor among several processors associated with the computer 201, a semiconductor-based microprocessor (in the form of a microchip or chip set), a macro-processor, or generally any device for executing instructions.

The memory device 210 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), flash drive, disk, hard disk drive, diskette, cartridge, cassette or the like, etc.). Moreover, the memory device 210 may incorporate electronic, magnetic, optical, and/or other types of storage media. Accordingly, the memory device 210 is an example of a tangible computer readable storage medium 240 upon which instructions executable by the processing device 205 may be embodied as a computer program product. The memory device 210 can have a distributed architecture, where various components are situated remote from one another, but can be accessed by the processing device 205.

The instructions in memory device 210 may include one or more separate programs, each of which comprises an ordered listing of executable instructions for implementing logical functions. In the example of FIG. 2, the instructions in the memory device 210 include a suitable operating system (OS) 211 and program instructions 216. The operating system 211 essentially controls the execution of other computer programs and provides scheduling, input-output control, file and data management, memory management, and communication control and related services. When the computer 201 is in operation, the processing device 205 is configured to execute instructions stored within the memory device 210, to communicate data to and from the memory device 210, and to generally control operations of the computer 201 pursuant to the instructions. Examples of program instructions 216 can include instructions to implement the DEA interactive user display 134, the DEA user input interface 135, the PG interactive user display 136, and/or the PG user input interface 137 of FIG. 1, where the system 200 is an embodiment of the user system 106 of FIG. 1. Further examples of the program instructions 216 can include instructions to implement the DEA application 130 and PG application 132 of FIG. 1, the query processor 116 of FIG. 1, and the remote applications 122 of FIG. 1.

The computer 201 of FIG. 2 also includes a network interface 260 that can establish communication channels with one or more other computer systems via one or more network links. The network interface 260 can support wired and/or wireless communication protocols known in the art. For example, when embodied in the user system 106 of FIG. 1, the network interface 260 can establish communication channels with the application server 102 and the mediation layer gateway 104 of FIG. 1.

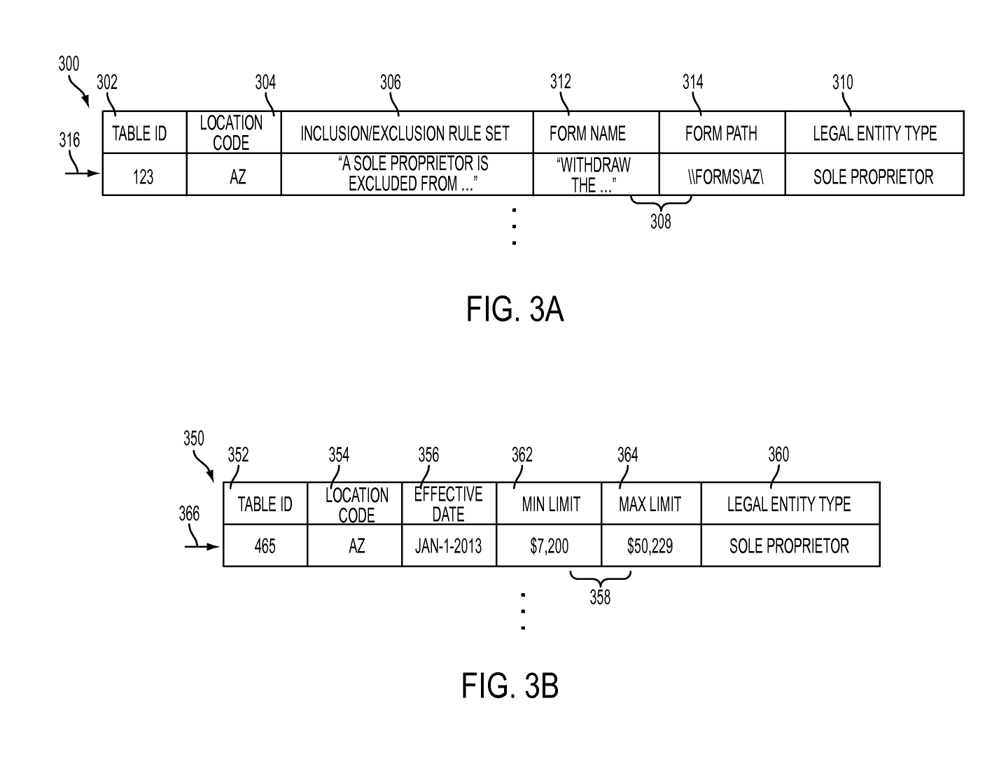

Turning now to FIG. 3A, an example of a policy guidance table 300 is depicted as may be included in the policy guidance data 112 of FIG. 1. The policy guidance table 300 represents a collection of data values that can be selected, for instance, based on a selection via the PG user input interface 137 of FIG. 1. The policy guidance table 300 may be populated based on published data sources or extracted from the remote data 124 of FIG. 1. The policy guidance table 300 can also be populated using links to preexisting forms and by extracting form names from the preexisting forms. In the example of FIG. 3A, the policy guidance table 300 is formatted to provide guidance and forms based on a geographic location and legal entity type to support generating insurance quotes, such as workers compensation insurance quotes.

The policy guidance table 300 of FIG. 3A includes a table identifier 302, a location code 304, inclusion and exclusion rule set 306, form data 308, and a legal entity type 310. The form data 308 can include a form name 312 and a form path 314 to a form saved as a file in the data storage system 110 or auxiliary data storage system 110A of FIG. 1. The table identifier 302 may serve as an index to a particular entry or row 316 in the policy guidance table 300.

The location code 304 can be a text field, such as a two-digit state code or a numeric code used to map to a location code formatted with any number of characters. For example, the location code 304 could be formatted to include a value of “AZ” for the state of Arizona or a number that serves as an index to a separate table (not depicted), e.g., numeric code “03” mapping to “Arizona”. The inclusion and exclusion rule set 306 may define rules about the types of individuals (typically owners, officers, etc.) that can be included in or excluded from coverage, such as workers compensation insurance coverage, based on the geographic location defined by the location code 304. The inclusion and exclusion rule set 306 can be further refined as separate entries for different legal entity types as defined by the legal entity type 310 for a same geographic location defined by the location code 304. For example, separate entries or rows 316 can be defined for the state of Arizona as the location code 304 for legal entity types 310 of sole proprietor and corporation. Each geographic location defined by the location code 304 can have one or more forms defined in the form data 308, such as compliance forms, that are location specific. For legal entity types 310 that have common definitions, the legal entity type 310 may be defined as a compound entry, such as a common entry or row 316 for a sole proprietor and a partnership. Additional fields may also be included in the policy guidance table 300 beyond those depicted in FIG. 3A. Furthermore, the policy guidance table 300 can be subdivided or distributed into one or more additional tables. The fields in the policy guidance table 300 can be arranged in any order and may also be elements of other tables.

FIG. 3B depicts an example of a minimum-maximum guide table 350 that defines minimum-maximum guidance for payroll reporting purposes associated with the coverage. The minimum-maximum guide table 350 can be defined separately from the policy guidance table 300 of FIG. 3A or be merged with the policy guidance table 300 of FIG. 3A. In the example of FIG. 3B, the minimum-maximum guide table 350 includes a table identifier 352, a location code 354, an effective date 356, limit data 358, and a legal entity type 360. The limit data 358 can include a minimum limit 362 and a maximum limit 364. The limit data 358 can further include other limitations (not depicted), such as a flat limit (i.e., no min/max) and special rules (e.g., construction rules, relation to tax filing status, etc.).

The table identifier 352 may serve as an index to a particular entry or row 366 in the minimum-maximum guide table 350. Similar to the location code 304 of FIG. 3A, the location code 354 can be a text field, such as a two-digit state code or a numeric code used to map to a location code formatted with any number of characters. The effective date 356 can indicate when the limit data 358 went into force for the geographic location defined by the location code 354. The minimum limit 362 and maximum limit 364 can be payroll limitations for owners and/or officers of a business entity as defined by the legal entity type 360 for use in preparing a workers compensation insurance policy. The payroll limitations define a payroll range used to designate an individual's payroll under the policy. For example, if the minimum limit 362 for an officer of a business entity was $25,000 and the maximum limit 364 was $100,000, the officer would designate $25,000 as payroll on the policy if his income was $25,000 or less. Further, the officer would designate $100,000 as payroll on the policy if his income was $100,000 or more. If his income was between $25,000 and $100,000, he would designate his actual income as payroll on the policy.

In an alternate embodiment, the minimum-maximum guide table 350 is omitted, and minimum-maximum guidance is defined as a file stored in the data storage system 110 or auxiliary data storage system 110A of FIG. 1. When stored as a separate file, a file date (not depicted) may also be used to indicate overall freshness of the minimum-maximum guidance.

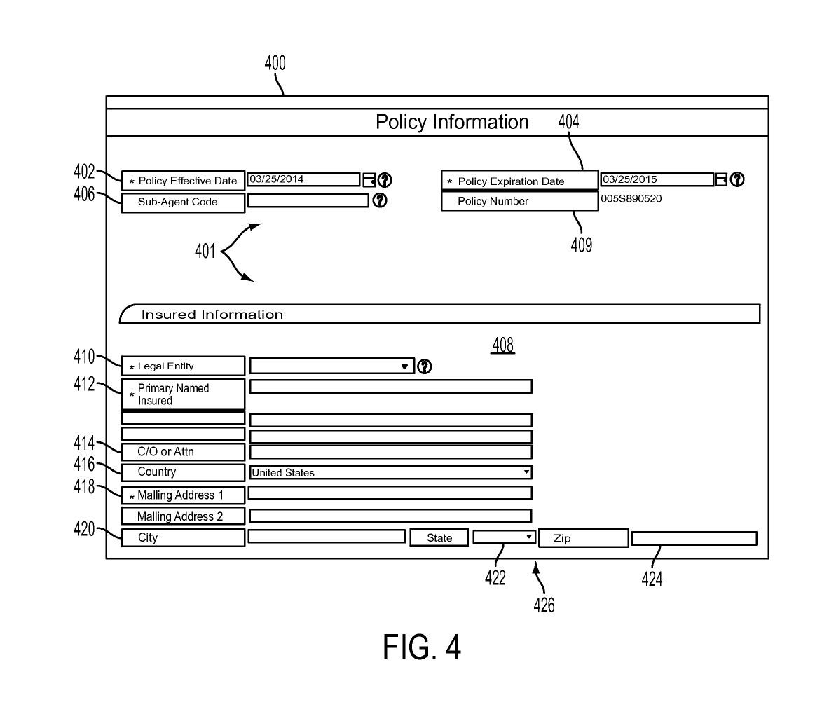

FIG. 4 depicts an example of an interactive user display 400 and user input interface 401 to populate information related to an insurance policy, for instance, as one instance of the DEA interactive user display 134 and DEA user input interface 135 of FIG. 1. The interactive user display 400 can prompt a user to enter a number of values related to an insurance policy, where the user input interface 401 defines a data entry interface for collecting information such as a policy effective date 402, a policy expiration date 404, a sub-agent code 406, and insured information 408. When a policy quote is initiated, a policy number 409 may be generated by the DEA application 130 of FIG. 1 to track data associated with developing the quote as values are populated. The policy effective date 402 and policy expiration date 404 bound the term of the potential policy and may be used to select particular data sets from the data storage system 110 and/or auxiliary data storage system 110A of FIG. 1 that are date sensitive, such as the effective date 356 of FIG. 3B. The sub-agent code 406 may be used to identify an agent preparing the quote. The insured information 408 may include a legal entity 410, a primary named insured 412, a “care of” or “attention” identifier 414, a country 416, a mailing address 418 (e.g., street address), a city 420, a state 422, and a ZIP code 424. The legal entity 410 can be selectable from a list of legal entity types, such as a corporation, a general partnership, a limited liability partnership, a limited liability company, a sole proprietorship, and the like. Numerous other data items can also be collected using a series of fields or questions. The city 420, state 422, and/or ZIP code 424 are examples of geographic locations that can impact the selection of data as constrained by the geographic location-based rules of FIGS. 3A and 3B. For example, the state 422 may map to the location code 304, 354 of FIGS. 3A and 3B as a geographic location indicator 426 defining a predominant state of a business or another state or jurisdiction in which the business operates. For businesses operating in multiple states, data can be collected about each state or geographic location in which the business has workers. In order to prepare an insurance policy, a number of additional data values must be collected and accurately classified.

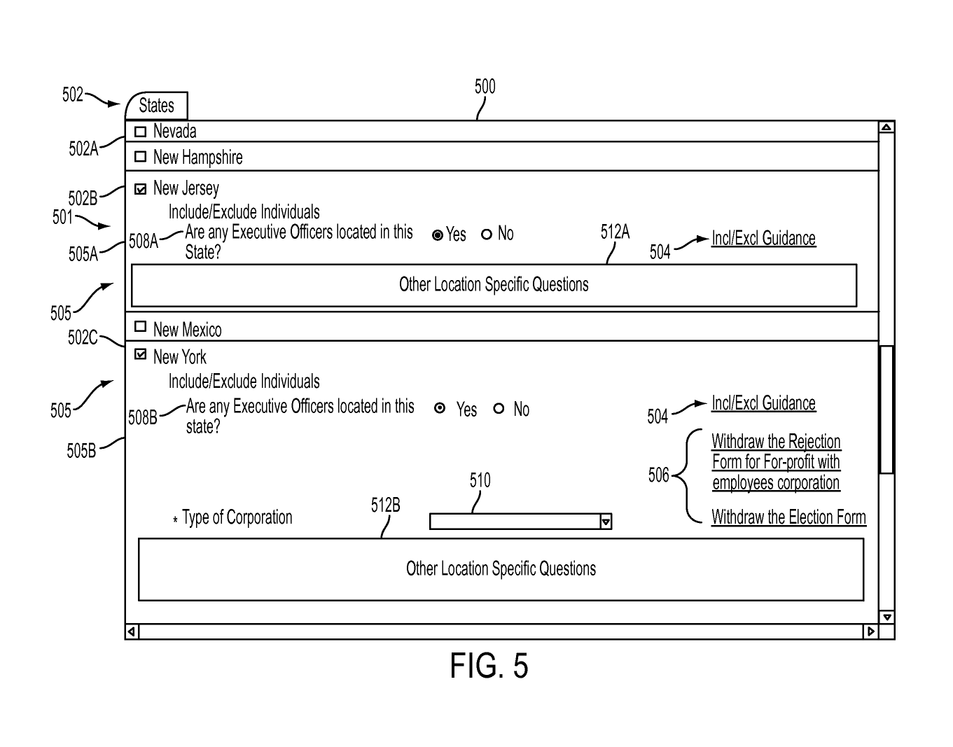

FIG. 5 depicts an embodiment of the interactive user display 500 and user input interface 501 for geographic location selection as an example of the PG interactive user display 136 and PG user input interface 137 of FIG. 1. The interactive user display 500 may be displayed on a user system 106 of FIG. 1. The user input interface 501 can include a list of geographic locations 502 that can be selected to indicate where an entity has assets. The geographic locations 502 can be states where an entity, such as a business, has a facility with one or more workers. In the context of preparing a workers compensation insurance application, the geographic locations 502 to be selected can include the geographic location indicator 426 of FIG. 4 defining a predominant state of a business, as well as other states or jurisdictions in which the entity has business locations. In the example of FIG. 5, some of the geographic locations 502 are not selected, such as unselected geographic location 502A, while other geographic locations 502 are selected, such as selected geographic locations 502B and 502C. Although the example of FIG. 5 depicts a pair of selected geographic locations 502B and 502C, embodiments can operate on a single selected geographic location and/or on a greater number of selected geographic locations.

The PG application 132 of FIG. 1 can determine which of the geographic locations 502 are selected, such as selected geographic locations 502B and 502C. The PG application 132 of FIG. 1 may analyze each of the selected geographic locations 502B, 502C to determine an inclusion and exclusion rule set specific to each of the selected geographic locations 502B, 502C. For example, with respect to FIGS. 1, 3A, and 5, upon a user action of selecting the selected geographic location 502B, the application server 102 or user system 106 can pass a request through the mediation layer gateway 104 to the query server 108 where the query processor 116 can access the data storage system 110 and/or auxiliary data storage system 110A to determine an inclusion and exclusion rule set 306 specific to the selected geographic location 502B. The selected geographic location 502B can be matched against the location code 304 of FIG. 3A, and the legal entity 410 of FIG. 4 can be matched against the legal entity type 310 of FIG. 3A. Similar matching can be performed on other selections, such as the selected geographic location 502C. Upon identifying a matching entry or row 316 of FIG. 3A, based on the location code 304 and optionally the legal entity type 310, a link 504 can be generated between each of the selected geographic locations 502B, 502C and the inclusion and exclusion rule set 306 of FIG. 3 specific to each of the selected geographic locations 502B, 502C. The link 504 can be a hyperlink that triggers a corresponding action based on a user selection.

A record set 505 is output on the interactive user display 500 that includes records 505A and 505B of the selected geographic locations 502B, 502C and an instance of the link 504 for each of the selected geographic locations 502B, 502C operable to display the inclusion and exclusion rule set 306 of FIG. 3A specific to each of the selected geographic locations 502B, 502C based on a link 504 selection. The output can alter the interactive user display 500 to expand information displayed for each of the geographic locations 502 upon transitioning from being unselected to being selected, where expanded information may represent records 505A and 505B of record set 505.

Each of the selected geographic locations 502B, 502C can be analyzed to determine whether one or more compliance forms based on form data 308 of FIG. 3A are associated with each of the selected geographic locations 502B, 502C. A compliance form link 506 can be generated between each of the selected geographic locations 502B, 502C and one or more compliance forms specific to each of the selected geographic location 502B, 502C. Compliance forms can be stored in the data storage system 110 and/or auxiliary data storage system 110A of FIG. 1, with a path to each of the compliance forms defined in the form path 314 of FIG. 3A. In generating the compliance form link 506, the form name 312 of FIG. 3A can be used as textual description for display on the interactive user display 500. An instance of the compliance form link 506 can be output for each of the selected geographic locations 502B, 502C operable to access the one or more compliance forms specific to each of the selected geographic locations 502B, 502C based on a compliance form link 506 selection. Each compliance form link 506 may function as a hyperlink or trigger to display various output options for an associated compliance form. For example, options can include: opening one or more compliance forms for on-screen display; sending one or more compliance forms to a printer, and/or including one or more compliance forms in an electronic message.

Selection of the geographic locations 502 can result in displaying one or more questions on the on the interactive user display 500. Customized questions can be incorporated in the record set 505 on the interactive user display 500 based on the legal entity type 310 of FIG. 3A and rules associated with each of the selected geographic locations 502B, 502C. For example, question 508A in record 505A can be associated with legal entity type 310 of FIG. 3A matching the legal entity 410 of FIG. 4 for selected geographic location 502B, where a response to question 508A may be used in determining whether at least one party is subject to minimum-maximum guidance. Similarly, question 508B in record 505B can be associated with legal entity type 310 of FIG. 3A matching the legal entity 410 of FIG. 4 for selected geographic location 502C, where a response to question 508B may be used in determining whether at least one party is subject to minimum-maximum guidance. An additional selection interface 510 may also be displayed based on the legal entity 410 of FIG. 4 for selected geographic location 502C. The selected geographic locations 502B and 502C can respectively have other location-specific questions 512A and 512B that may be generic or customized based on geographic location 502, legal entity 410 of FIG. 4, and/or other factors. The questions 508A and 508B, data associated with the additional selection interface 510, and other location-specific questions 512A and 512B may be stored in the data storage system 110 and/or auxiliary data storage system 110A of FIG. 1 as files or tables and may be incorporated in the policy guidance table 300 of FIG. 3A, in the minimum-maximum guide table 350 of FIG. 3B, and/or other tables not depicted.

When a user deselects one of the selected geographic locations 502B, 502C, an associated record 505A, 505B of the record set 505 can be cleared from memory, such as from the memory device 210 of FIG. 2. The interactive user display 500 can be adjusted to remove any data or links associated with a cleared record 505A, 505B when an associated selected geographic location 502B, 502C has been de-selected.

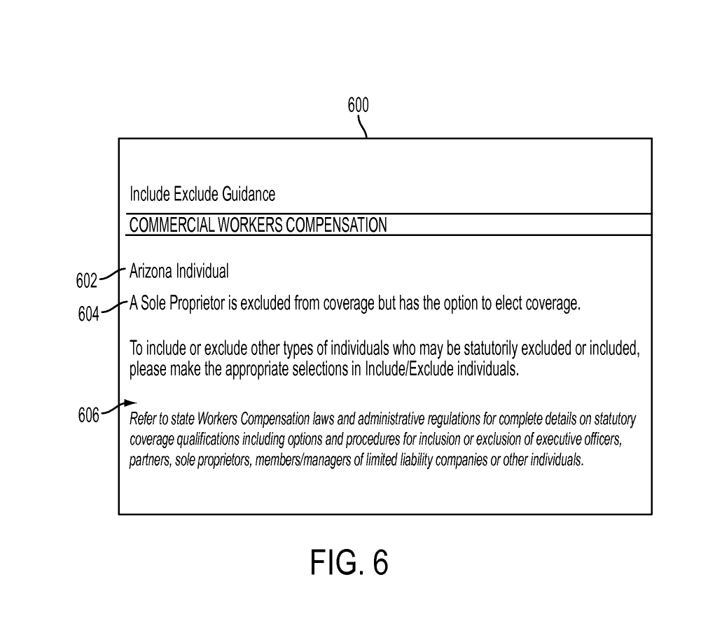

FIG. 6 depicts an example of include-exclude guidance 600 according to an embodiment. Upon selecting a link 504 of FIG. 5, the include-exclude guidance 600 can be displayed. The include-exclude guidance 600 may be presented as a template populated with information from a corresponding selected geographic location, such as selected geographic location 502B, 502C of FIG. 5 and legal entity 410 of FIG. 4 as a targeted worker type 602. In the example of FIG. 6, a selected geographic location is the state of Arizona and the legal entity is a sole proprietor. Detailed guidance 604 may be populated with data from the inclusion and exclusion rule set 306 of FIG. 3A with a location code 304 of FIG. 3A corresponding to the selected geographic location. The include-exclude guidance 600 may also include general guidance 606 that is applicable across multiple geographic locations and legal entity types. The include-exclude guidance 600 may be dynamically created upon selection of a link 504 of FIG. 5 or retrieved from a file in the data storage system 110 and/or auxiliary data storage system 110A of FIG. 1 and displayed in response to selection of a link 504 of FIG. 5.

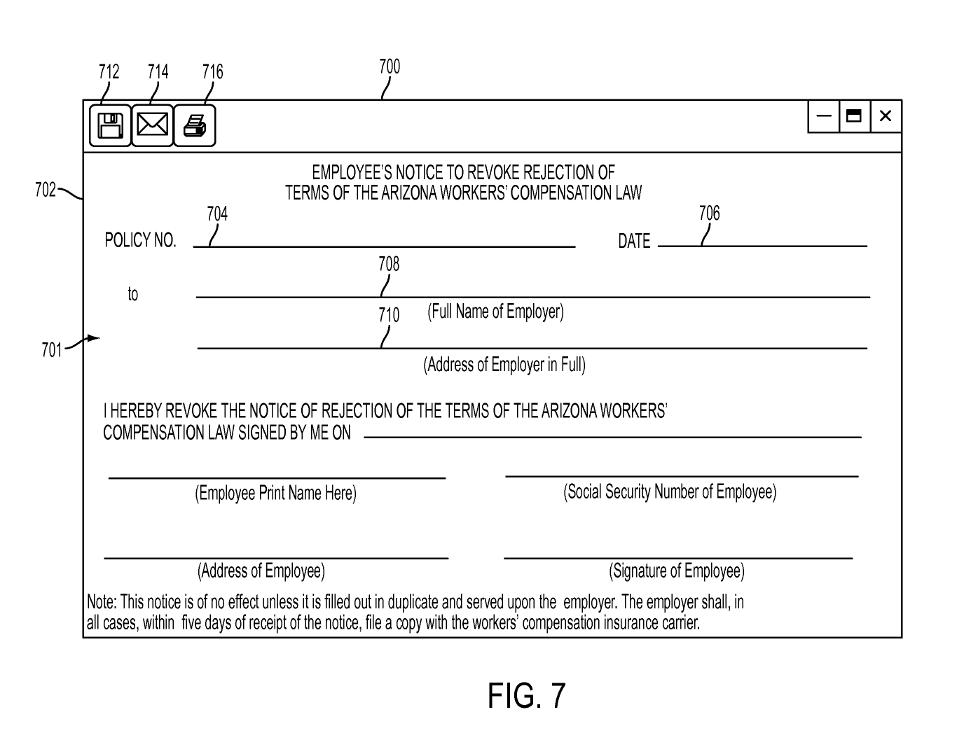

FIG. 7 depicts an example of a compliance form 702 according to an embodiment. The compliance form 702 can be displayed on an interactive user display 700 with a user input interface 701 as depicted in FIG. 7. In an alternate embodiment, the compliance form 702 is a static form without any direct input capability. The compliance form 702 is an example of a form that can be displayed upon selection of a compliance form link 506 of FIG. 5. In one embodiment, the compliance form 702 is a blank form related to a particular geographic location, such as one of the selected geographic locations 502B, 502C of FIG. 5. In an alternate embodiment, a number of fields in the compliance form 702 are automatically populated by the PG application 132 of FIG. 1 with data collected by the DEA application 130 of FIG. 1, the PG application 132, and/or other application (not depicted). For example a policy number 704 can be populated with the policy number 409 of FIG. 4; a date field 706 can be populated with the current date; an employer name 708 can be populated with the primary named insured 412 of FIG. 4; and, an address 710 can be populated with a combination of the mailing address 418, city 420, state 422, and ZIP code 424 of FIG. 4. Other fields (not depicted) may also be automatically populated. The compliance form 702 may also support direct data entry for one or more fields. The compliance form 702 can also include a number of options to save 712, e-mail 714, and/or print 716 the compliance form 702, including any data automatically or manually entered.

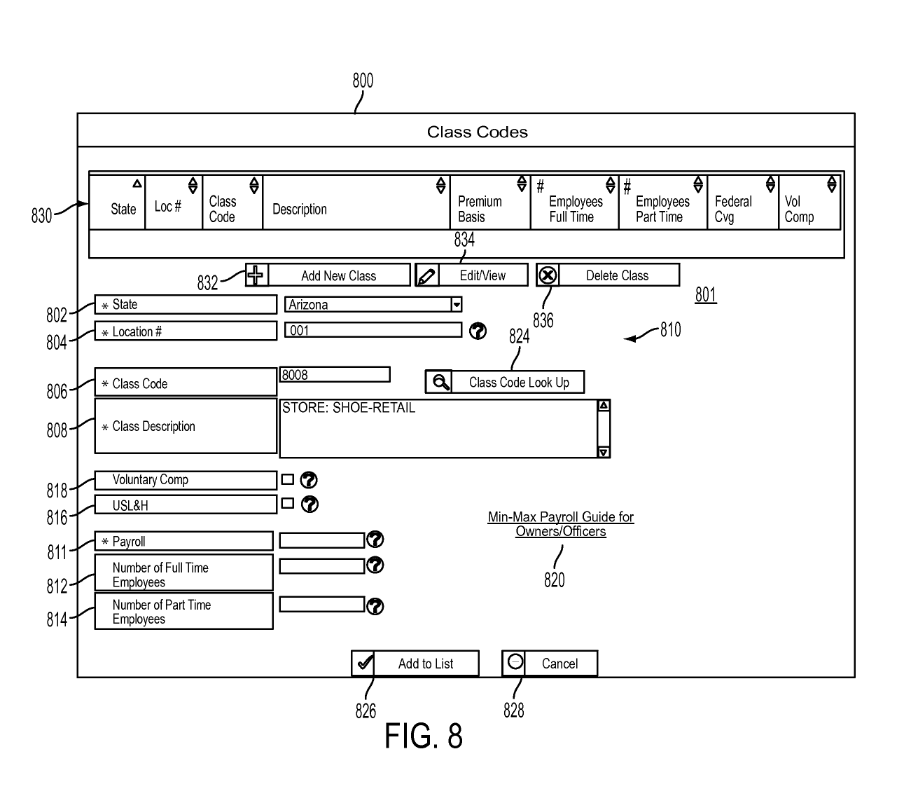

FIG. 8 depicts an example of an interactive user display 800 and user input interface 801. The user input interface 801 is an example of a classification code interface that can populate a classification record 810. Creation and editing of the classification record 810 may be performed as part of a quotation or insurance policy preparation process that uses location-based policy guidance. For instance, in the context of a workers compensation insurance policy, worker types and quantities at each geographic location of the business entity must be recorded. Worker classification codes can be state mandated with numerous definitions that must be accurately selected and tracked. In the example of FIG. 8, the user input interface 801 includes a geographic location 802, a location number 804, a numeric classification code 806, and a description 808. The geographic location 802 can be constrained as a pull-down input to select a valid option from a list. The geographic location 802 may be prefilled to display one of the selected geographic locations 502B, 502C of FIG. 5 in a user-modifiable format. The location number 804 may be a code to uniquely identify different facility locations of the business entity. The numeric classification code 806 and a corresponding description 808 are defined according to the National Council on Compensation Insurance (NCCI) or state rating bureau of the geographic location 802.

A payroll field 811 can also be populated when creating the classification record 810. The payroll field 811 may be constrained by various minimum and maximum payroll rules, a number of which may be directly accessible via a minimum-maximum guide link 820. In embodiments where minimum-maximum guidance is generally provided as a non-customized list, the minimum-maximum guide link 820 may be available regardless of whether at least one party subject to minimum-maximum guidance is located at the geographic location 802. In an alternate embodiment, the minimum-maximum guide link 820 is provided based on determining that at least one party subject to minimum-maximum guidance is located in a selected geographic location identified by the geographic location 802. As one example, the questions 508A, 508B of FIG. 5 can be used to determine whether at least one party subject to minimum-maximum guidance is located in one of the selected geographic locations 502B, 502C of FIG. 5 as a minimum-maximum selection. In the example of FIG. 8, the minimum-maximum guide link 820 is displayed as a selectable link, such as a hyperlink, on a classification input interface. Where the minimum-maximum guide link 820 is dynamically added to the interactive user display 800, the minimum-maximum guide link 820 can be removed based on detecting a change to the minimum-maximum selection indicating that no party subject to minimum-maximum guidance is located at the geographic location 802, e.g., based on responses to the questions 508A, 508B of FIG. 5.

A number of other fields can also be populated when creating the classification record 810, such as a number of full time employees 812, a number of part time employees 814, a federal coverage field 816, and a voluntary compensation field 818. The federal coverage field 816 can indicate whether the employees at a particular location defined by the geographic location 802 and location number 804 qualify for coverage under the U.S. Longshore and Harbor (USL&H) Workers Compensation Act, for example. The voluntary compensation field 818 may be used to indicate whether additional insurance coverage is desired beyond the minimum requirements to comply with various workers compensation insurance laws and regulations.

A class code look up 824 can trigger a lookup operation to assist in populating the numeric classification code 806 and description 808. An Add-to-List button 826 may be selected by a user to save any updates to data in fields 802-818 in a list 830 of classification records, while a Cancel button 828 can prevent any changes to data in the fields 802-818 from being saved. An Add New Class button 832 can add additional classification records to the list 830. Classification records in the list 830 can be edited and/or viewed using an Edit/View button 834. Classification records can be deleted from the list 830 using a Delete Class button 836.

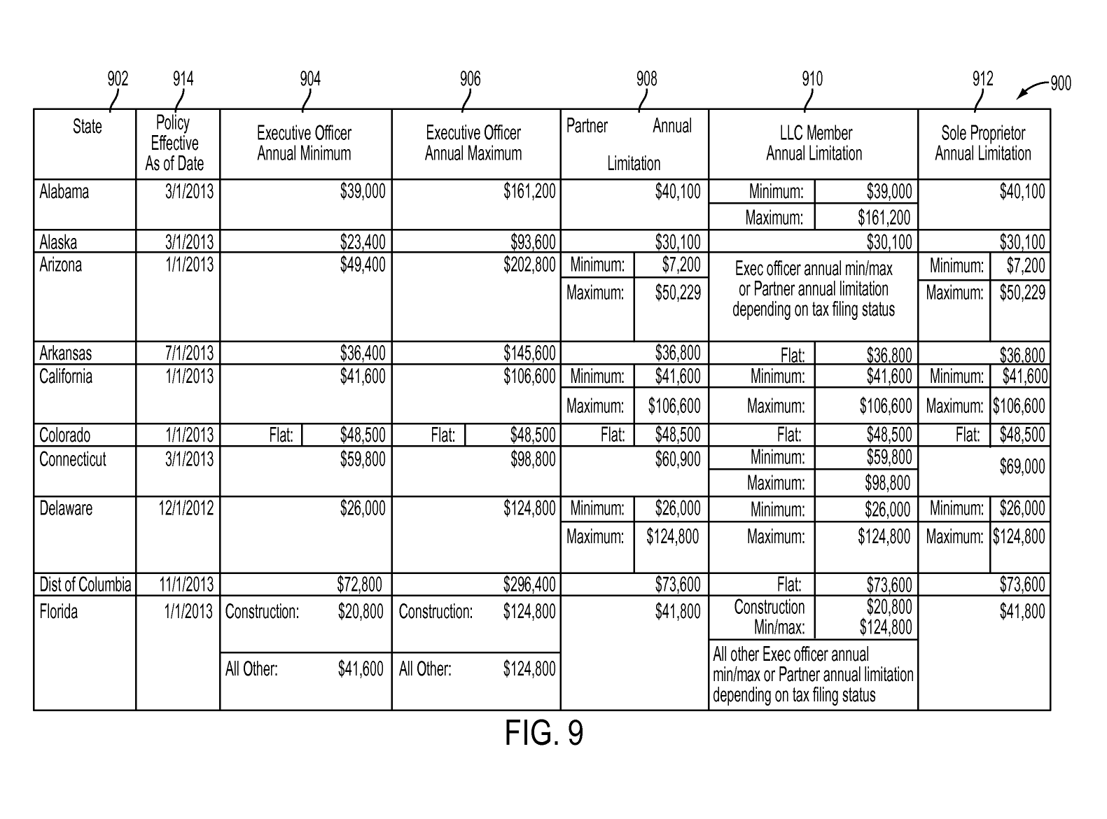

FIG. 9 depicts an example of a minimum-maximum guide 900 as a type of payroll limitation guide for use in populating the payroll field 811 of FIG. 8. The minimum-maximum guide 900 or a portion thereof can be displayed based on detecting a selection of the minimum-maximum guide link 820 of FIG. 8. The minimum-maximum guide 900 can display data for one or more geographic locations 902 and limitations for one or more legal entity types. For example, the minimum-maximum guide 900 may display an executive officer annual minimum 904, an executive officer annual maximum 906, a partner annual limitation 908, a limited liability company annual limitation 910, a sole proprietor annual limitation 912, and an effective date 914. A number of fields, such as the partner annual limitation 908, limited liability company annual limitation 910, and sole proprietor annual limitation 912 can include various rule subsets of constraints for minimum, maximum, or flat values. The fields 904-912 may also include subdivisions to make further distinctions on business/industry type, tax filing status, and/or other constraints. The minimum-maximum guide 900 may be a file retrieved from the data storage system 110 and/or auxiliary data storage system 110A of FIG. 1. Alternatively, the minimum-maximum guide 900 can be filtered or dynamically constructed based on the minimum-maximum guide table 350 of FIG. 3B. For example, the geographic location 802 of FIG. 8 can be used to extract data from the minimum-maximum guide table 350 of FIG. 3B having a corresponding location code 354. The effective date 914 can be populated based on the effective date 356 of FIG. 3B. Limit data 358 and legal entity type 360 of FIG. 3B can be used to populate fields 904-912. The minimum-maximum guide 900 may support filtering to limit the amount of data presented to the user. For example, filtering of data in the minimum-maximum guide 900 can be based on geographic location 802 of FIG. 8 and/or type of legal entity 410 of FIG. 4. The minimum-maximum guide 900 may be a minimum-maximum payroll guide for owners and/or officers for use in quoting a workers compensation insurance policy. The filtering of data in the minimum-maximum guide 900 can be further based on a policy effective date 402 of FIG. 4 for the workers compensation insurance policy relative to the effective date 914 and/or effective date 356 of FIG. 3B.

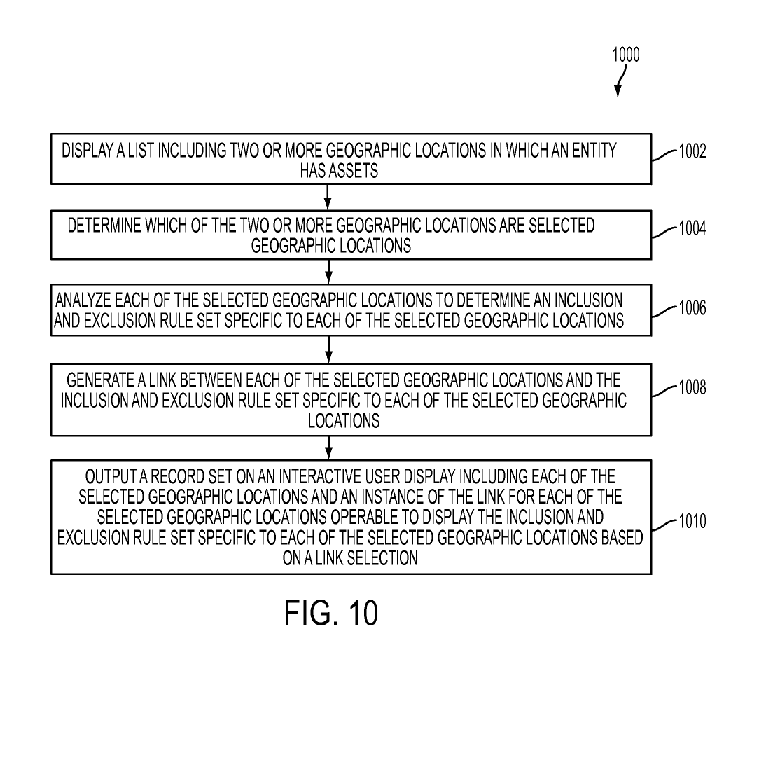

Turning now to FIG. 10, a process flow 1000 is depicted according to an embodiment. The process flow 1000 includes a number of steps that may be performed in the depicted sequence or in an alternate sequence. The process flow 1000 may be performed by the system 100 of FIG. 1. In one embodiment, the process flow 1000 is performed by the application server 102 of FIG. 1. In another embodiment, the process flow 1000 is performed by the user system 106 of FIG. 1.

At step 1002, a list is displayed that includes two or more geographic locations in which an entity has assets, such as geographic locations 502 of FIG. 5. At step 1004, the PG application 132 of FIG. 1 can determine which of the two or more geographic locations are selected geographic locations, such as the selected geographic locations 502B and 502C of FIG. 5. At step 1006, each of the selected geographic locations is analyzed to determine an inclusion and exclusion rule set specific to each of the selected geographic locations, such as inclusion and exclusion rule set 306 of FIG. 3A. The inclusion and exclusion rule set specific to each of the selected geographic locations may be a state-specific inclusion and exclusion guide for workers compensation insurance. At step 1008, a link, such as link 504 of FIG. 5, is generated between each of the selected geographic locations and the inclusion and exclusion rule set specific to each of the selected geographic locations.

At step 1010, a record set is output on an interactive user display, such as record set 505 of FIG. 5. The record set can include each of the selected geographic locations and an instance of the link for each of the selected geographic locations operable to display the inclusion and exclusion rule set specific to each of the selected geographic locations based on a link selection. The system 100 of FIG. 1 may also determine a legal entity type of the entity and incorporate customized questions in the record set based on the legal entity type and rules associated with each of the selected geographic locations. For example, displayed elements can be customized for particular states and legal entity types, such as different questions for a corporation versus a partnership. A business type selection (not depicted) may also change the display, e.g., construction vs. non-construction.

A user can make additional adjustments, such as de-selecting one or more of the selected geographic locations, e.g., de-selecting the selected geographic location 502B. A record of the record set can be cleared based on determining that an associated selected geographic location has been de-selected. The interactive user display, e.g., interactive user display 500 of FIG. 5, may be adjusted based on clearing a record. Responses to questions, such as questions 508A, 508B, can also modify the display by adding or removing links to appropriate forms. By dynamically adjusting the presentation to more closely align with selected scenarios, fewer overall links need to be generated and displayed, thus improving processing system performance by avoiding generation and presentation of links to existing but irrelevant information. The customized link population and question presentation can reduce the risk of errant form selection and prevent collection of additional data that may not be needed for a particular scenario, thereby reducing extraneous data collection and improving storage system efficiency.

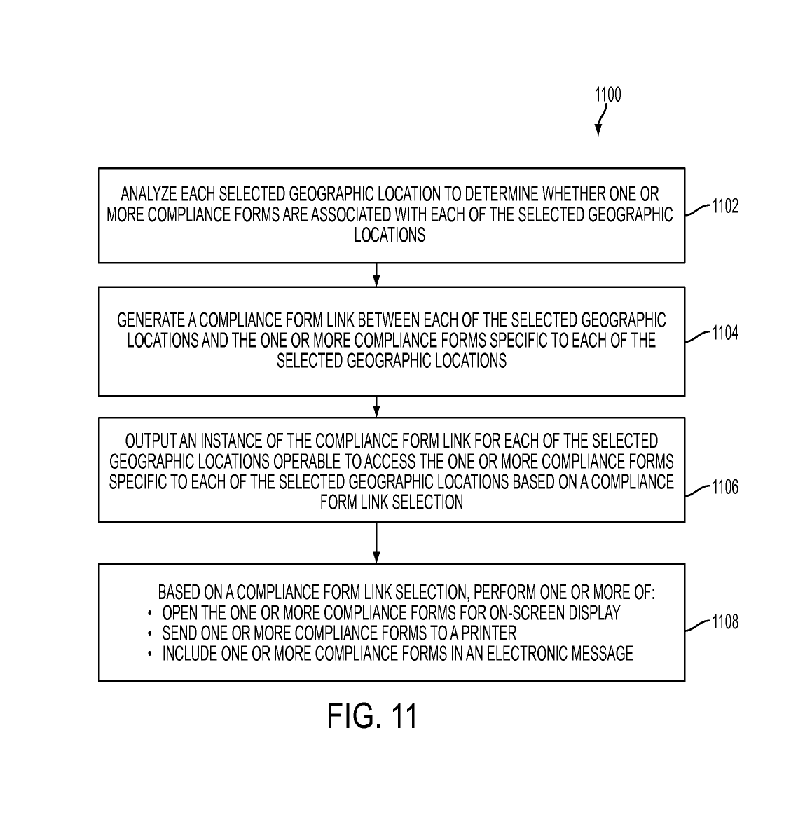

FIG. 11 depicts a process flow 1100 according to an embodiment. The process flow 1100 links forms based on selected geographic locations of the process flow 1000 of FIG. 10 and may be implemented by the PG application 132 of FIG. 1. The process flow 1100 includes a number of steps that may be performed in the depicted sequence or in an alternate sequence.

At step 1102, each of the selected geographic locations, such as selected geographic locations 502B and 502C of FIG. 5, can be analyzed to determine whether one or more compliance forms, such as compliance form 702 of FIG. 7, are associated with each of the selected geographic locations. At step 1104, a compliance form link, such as a compliance form link 506 of FIG. 5, may be generated between each of the selected geographic locations and one or more compliance forms specific to each of the selected geographic locations. At step 1106, an instance of the compliance form link is output for each of the selected geographic locations operable to access one or more compliance forms specific to each of the selected geographic locations based on a compliance form link selection as depicted in the example of FIG. 5. At step 1108, based on a compliance form link selection, one or more of the following may be performed: one or more compliance forms may be opened for on-screen display; one or more compliance forms may be sent to a printer; and/or one or more compliance forms can be included in an electronic message.

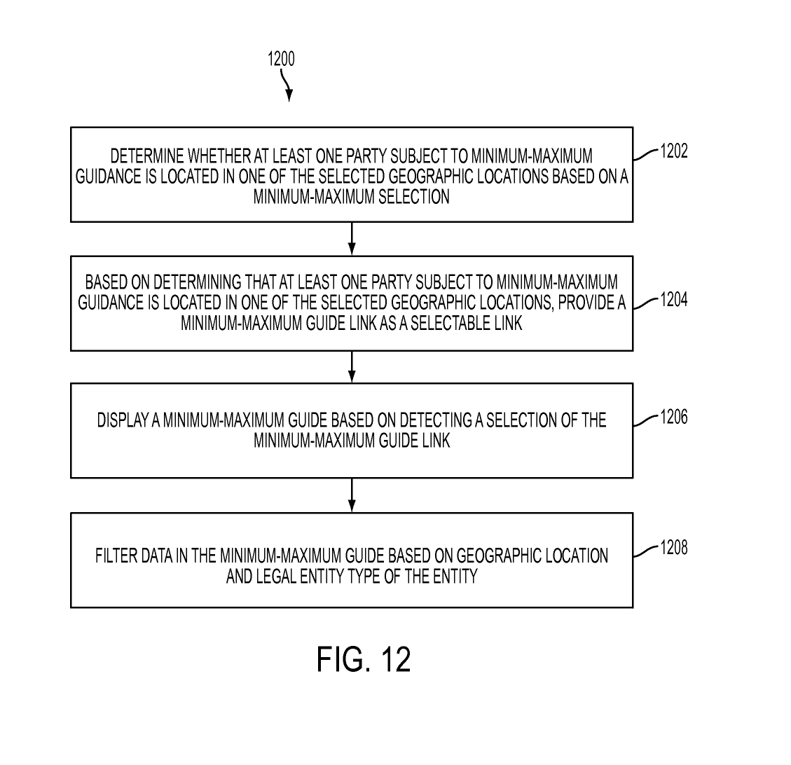

FIG. 12 depicts a process flow 1200 according to an embodiment. The process flow 1200 visually depicts steps that may be taken for minimum-maximum guidance and may be implemented by the PG application 132 of FIG. 1. The process flow 1200 includes a number of steps that may be performed in the depicted sequence or in an alternate sequence.

At step 1202, the PG application 132 of FIG. 1 can determine whether at least one party subject to minimum-maximum guidance is located in one of the selected geographic locations based on a minimum-maximum selection, e.g., by reviewing responses to the questions 508A and 508B of FIG. 5. At step 1204, based on determining that the at least one party subject to minimum-maximum guidance is located in one of the selected geographic locations, a minimum-maximum guide link can be provided, such as the minimum-maximum guide link 820 of FIG. 8.

At step 1206, the minimum-maximum guide link can be displayed as a selectable link, for instance, on a classification input interface, and the minimum-maximum guide, such as minimum-maximum guide 900 of FIG. 9, may be displayed based on detecting a selection of the minimum-maximum guide link. As previously described, the minimum-maximum guide can be a minimum-maximum payroll guide for owners and/or officers to quote a workers compensation insurance policy.

At step 1208, data in the minimum-maximum guide may be filtered based on geographic location and legal entity type of the entity. As such, only a subset of data in the minimum-maximum guide may be displayed to the user. Alternatively, the minimum-maximum guide can be displayed in its entirety including all geographic locations and legal entity types. At a further alternative, filtering can be selectable to allow the user to change the viewing perspective between showing all data and limiting the view based on geographic location, legal entity type, and/or other criteria. For instance, filtering of the data in the minimum-maximum guide 900 of FIG. 9 may be further based on an effective policy date for a workers compensation insurance policy.

The PG application 132 of FIG. 1 can monitor for changes to various inputs that may impact the need to display the minimum-maximum guide. For example, the minimum-maximum guide link 820 of FIG. 8 can be removed based on detecting a change to the minimum-maximum selection indicating that no party subject to minimum-maximum guidance is located in one of the selected geographic locations, e.g., de-selecting the selected geographic locations 502B or 502C of FIG. 5.

It will be appreciated that aspects of the present invention may be embodied as a system, method, or computer program product and may take the form of a hardware embodiment, a software embodiment (including firmware, resident software, micro-code, etc.), or a combination thereof. Furthermore, aspects of the present invention may take the form of a computer program product embodied in one or more computer readable medium(s) having computer readable program code embodied thereon.

One or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium may be a tangible medium containing or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

What is claimed is:

1. A system, comprising:
a processing device; and
a memory device in communication with the processing device, the memory device storing instructions that when executed by the processing device result in:
displaying a list comprising two or more geographic locations in which an entity has assets;
determining which of the two or more geographic locations are selected geographic locations;
analyzing each of the selected geographic locations to determine an inclusion and exclusion rule set specific to each of the selected geographic locations;
generating a link between each of the selected geographic locations and the inclusion and exclusion rule set specific to each of the selected geographic locations; and
outputting a record set on an interactive user display comprising each of the selected geographic locations and an instance of the link for each of the selected geographic locations operable to display the inclusion and exclusion rule set specific to each of the selected geographic locations based on a link selection.

2. The system of claim 1, further comprising instructions that when executed by the processing device result in:
analyzing each of the selected geographic locations to determine whether one or more compliance forms are associated with each of the selected geographic locations;
generating a compliance form link between each of the selected geographic locations and the one or more compliance forms specific to each of the selected geographic locations; and
outputting an instance of the compliance form link for each of the selected geographic locations operable to access the one or more compliance forms specific to each of the selected geographic locations based on a compliance form link selection.

3. The system of claim 2, further comprising instructions that when executed by the processing device result in:
sending the one or more compliance forms to a printer based on the compliance form link selection.

4. The system of claim 2, further comprising instructions that when executed by the processing device result in:
opening the one or more compliance forms for on-screen display based on the compliance form link selection.

5. The system of claim 2, further comprising instructions that when executed by the processing device result in:
including the one or more compliance forms in an electronic message based on the compliance form link selection.

6. The system of claim 1, further comprising instructions that when executed by the processing device result in:
determining a legal entity type of the entity; and
incorporating customized questions in the record set based on the legal entity type and rules associated with each of the selected geographic locations.

7. The system of claim 1, wherein the inclusion and exclusion rule set specific to each of the selected geographic locations is a state-specific inclusion and exclusion guide for workers compensation insurance.

8. The system of claim 1, further comprising instructions that when executed by the processing device result in:
clearing a record of the record set based on determining that an associated selected geographic location has been de-selected; and
adjusting the interactive user display based clearing the record.

9. The system of claim 1, further comprising instructions that when executed by the processing device result in:
determining whether at least one party subject to minimum-maximum guidance is located in one of the selected geographic locations based on a minimum-maximum selection; and
based on determining that the at least one party subject to minimum-maximum guidance is located in one of the selected geographic locations, providing a minimum-maximum guide link.

10. The system of claim 9, wherein the minimum-maximum guide link is displayed as a selectable link on a classification input interface.

11. The system of claim 10, further comprising instructions that when executed by the processing device result in:
displaying a minimum-maximum guide based on detecting a selection of the minimum-maximum guide link.

12. The system of claim 11, further comprising instructions that when executed by the processing device result in:
filtering data in the minimum-maximum guide based on geographic location and legal entity type of the entity.

13. The system of claim 12, wherein the minimum-maximum guide is a minimum-maximum payroll guide for at least one of owners and officers to quote a workers compensation insurance policy, and wherein filtering of the data in the minimum-maximum guide is further based on an effective policy date for the workers compensation insurance policy.

14. The system of claim 9, further comprising instructions that when executed by the processing device result in:
removing the minimum-maximum guide link based on detecting a change to the minimum-maximum selection indicating that no party subject to minimum-maximum guidance is located in one of the selected geographic locations.

15. A computer program product comprising a storage medium embodied with computer program instructions that when executed by a computer cause the computer to implement:
displaying a list comprising two or more geographic locations in which an entity has assets;
determining which of the two or more geographic locations are selected geographic locations;
analyzing each of the selected geographic locations to determine an inclusion and exclusion rule set specific to each of the selected geographic locations;
generating a link between each of the selected geographic locations and the inclusion and exclusion rule set specific to each of the selected geographic locations; and
outputting a record set on an interactive user display comprising each of the selected geographic locations and an instance of the link for each of the selected geographic locations operable to display the inclusion and exclusion rule set specific to each of the selected geographic locations based on a link selection.

16. The computer program product of claim 15, further comprising computer program instructions that when executed by the computer cause the computer to implement:
analyzing each of the selected geographic locations to determine whether one or more compliance forms are associated with each of the selected geographic locations;
generating a compliance form link between each of the selected geographic locations and the one or more compliance forms specific to each of the selected geographic locations; and
outputting an instance of the compliance form link for each of the selected geographic locations operable to access the one or more compliance forms specific to each of the selected geographic locations based on a compliance form link selection.

17. The computer program product of claim 16, further comprising computer program instructions that when executed by the computer cause the computer to implement:
sending the one or more compliance forms to a printer based on the compliance form link selection.

18. The computer program product of claim 16, further comprising computer program instructions that when executed by the computer cause the computer to implement:
opening the one or more compliance forms for on-screen display based on the compliance form link selection.

19. The computer program product of claim 16, further comprising computer program instructions that when executed by the computer cause the computer to implement:
including the one or more compliance forms in an electronic message based on the compliance form link selection.

20. The computer program product of claim 15, further comprising computer program instructions that when executed by the computer cause the computer to implement:
determining a legal entity type of the entity; and
incorporating customized questions in the record set based on the legal entity type and rules associated with each of the selected geographic locations.

21. The computer program product of claim 15, further comprising computer program instructions that when executed by the computer cause the computer to implement:
clearing a record of the record set based on determining that an associated selected geographic location has been de-selected; and
adjusting the interactive user display based clearing the record.

22. The computer program product of claim 15, further comprising computer program instructions that when executed by the computer cause the computer to implement:
determining whether at least one party subject to minimum-maximum guidance is located in one of the selected geographic locations based on a minimum-maximum selection; and
based on determining that the at least one party subject to minimum-maximum guidance is located in one of the selected geographic locations, providing a minimum-maximum guide link.

23. The computer program product of claim 22, further comprising computer program instructions that when executed by the computer cause the computer to implement:
displaying a minimum-maximum guide based on detecting a selection of the minimum-maximum guide link.

24. The computer program product of claim 22, further comprising computer program instructions that when executed by the computer cause the computer to implement:
removing the minimum-maximum guide link based on detecting a change to the minimum-maximum selection indicating that no party subject to minimum-maximum guidance is located in one of the selected geographic locations.
